(19) United States
(12) Patent Application Publication
(10) Pub. No.: US 2010/0232058 A1
(43) Pub. Date: Sep. 16, 2010

(54) INFORMATION RECORDING MEDIUM GLASS SUBSTRATE, INFORMATION RECORDING MEDIUM, INFORMATION RECORDING APPARATUS AND MANUFACTURING METHOD OF INFORMATION RECORDING MEDIUM GLASS SUBSTRATE

(75) Inventors: Hideki KAWAI, Kobe-shi (JP); Katsuhiko ASAI, Toyonaka-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Tokyo (JP)

(21) Appl. No.: 12/783,732

(22) Filed: May 20, 2010

Related U.S. Application Data
(62) Division of application No. 11/186,264, filed on Jul. 21, 2005.

(30) Foreign Application Priority Data
Jul. 23, 2004 (JP) 2004-216564
May 13, 2005 (JP) 2005-141137
May 13, 2005 (JP) 2005-141138

(51) Int. Cl. G11B 5/596

(52) U.S. Cl. 360/78.04; G9B/5.216

(57) ABSTRACT

In an information recording apparatus such as a hard disk drive, a ramp for retreating its head from a recording medium when the apparatus is stopped is provided opposing the information recording medium. In such an information recording apparatus, the information recording medium may sometimes collide with the ramp when the apparatus falls down. By inclining a portion opposing the ramp of a glass substrate in the information recording medium, even if the information recording medium strikes the ramp, the information recording medium is prevented from being cracked.

The present application claims priority to Japanese Patent Application No. 2004-216564 filed Jul. 23, 2004, No. 2005-141137 filed May 13, 2005, and No. 2005-141138 filed May 13, 2005, the entire contents of which are hereby incorporated by reference.

### BACKGROUND OF THE INVENTION

1. Field of the Invention

The present invention relates to information recording medium glass substrate, information recording medium, information recording apparatus and manufacturing method of information recording medium glass substrate.

2. Description of the Related Art

As a substrate of a small hard disk drive for use in a notebook type personal computer, card type recording medium and the like, a glass substrate has been well known. As a hard disk drive for use in portable condition, there has been well known a ramp load type unit in which a magnetic head is retreated into a ramp outside a disk in order to protect the magnetic head and a recording layer of the disk from external shock when the unit is stopped and the magnetic head is allowed to slide out of the ramp when the unit is started to execute recording.

Although the ramp load type hard disk drive utilizes a magnetic disk which generates no special problem even if it is dropped or given a shock when it is incorporated in other unit than the ramp load type one, it has become evident that a problem that the glass substrate is destroyed occurs if a sudden shock such as fall and collision is given thereto. Particularly, this problem is conceivable when any glass substrate undergoing no strengthening is used.

FIG. 9 shows a typical example of the magnetic recording medium of a conventional hard disk drive. In a glass substrate 100 in which a magnetic recording layer 200 is formed in the surface thereof, its outside end portion has a structure shown in FIG. 10. That is, a flat chamfered portion 20 is formed between the main surface 10 and the side face 40 at the outside end portion. Such a magnetic recording medium is rotated around the center axis vertical to the glass substrate when reading and writing information. According to consideration of the inventor of the present invention, because the ramp is always located at a position where it overlap the recording medium when it is seen from a direction perpendicular to the main surface of the disk although it is departed from the disk, the recording medium collides with the ramp when it is deflected slightly, so that a particular stress is concentrated on a boundary portion 30 between the main surface 10 and the chamfered portion 20 at the outside end portion thereby the substrate being fractured.

To relax the concentration of stress on the boundary portion between the main surface and the chamfered portion, it can be considered to make a portion between the main surface and the chamfered portion into a curved face. As technology for providing a curved face between the main surface and the chamfered portion, those disclosed in Japanese Patent Application Laid-Open No. H10-154321 and Japanese Patent Application Laid-Open No. 2002-100031 have been well known.

However, the inventions described in the Japanese Patent Application Laid-Open No. H10-154321 and Japanese Patent Application Laid-Open No. 2002-100031 aim at preventing generation of particles due to rubbing between the corner portion of a glass substrate and an accommodating container and the above-described patent documents 1, 2 have not described how long the curved face is provided in order to prevent crack of the substrate due to collision with the ramp. These proposals premises an existence of a flat chamfered portion whose angle with respect to the main surface and outside face is substantially 45° and it is difficult to prevent crack of the substrate due to collision with the ramp. In reality, an information recording medium glass substrate taking into account prevention of cracks of the substrate due to collision with the ramp has not been proposed yet.

### SUMMARY OF THE INVENTION

A prominent object of the present invention is to provide an information recording medium glass substrate, an information recording medium, an information recording apparatus and manufacturing method of information recording medium glass substrate capable of preventing cracks of the substrate due to collision with the ramp.

As a result of advancing researches, this inventor has found out a solution of this problem by controlling the outside end portion to a predetermined shape and has reached the present invention.

That is, according to an aspect of the present invention, there is provided an information recording apparatus comprising:

an information recording medium in which recording layer is provided on a main surface of a glass substrate;
a drive mechanism for rotating the information recording medium around the center axis perpendicular to the glass substrate;
a head for executing read/write of the information recording medium;
a ramp disposed such that its front end overlaps the end portion of the information recording medium; and
a head drive mechanism for loading the head retreated to the ramp on the information recording medium and unloading the head to the ramp, wherein
the position of said main surface opposing said ramp is inclined with respect to said central axis.

The invention itself, together with further objects and attendant advantages, will best be understood by reference to the following detailed description taken in conjunction with the accompanying drawings.

### BRIEF DESCRIPTION OF THE DRAWINGS

FIG. 1 is a sectional view of an end portion of a glass substrate according to a first embodiment of the present invention;

FIG. 2 is a schematic view when the end portion of a glass substrate collides with a ramp;

FIG. 3 is a sectional view of the end portion of the glass substrate according to the second embodiment of the present invention;

FIG. 4 is a sectional view of the end portion of the glass substrate according to the third embodiment of the present invention;

FIG. 5 is a sectional view of the end portion of the glass substrate according to the fourth embodiment of the present invention;

FIG. 6 is a sectional view of the end portion of the glass substrate according to the fifth embodiment of the present invention;

FIG. 7 is a sectional view of the end portion of the glass substrate according to the sixth embodiment of the present invention;

FIG. 8 is a disassembly sectional view of an information recording apparatus;

FIG. 9 is a perspective view of the information recording medium; and

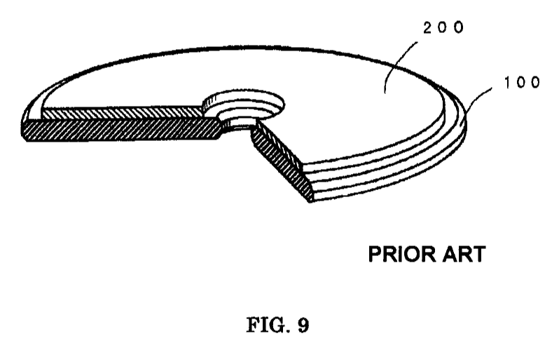

FIG. 10 is a sectional view of the end portion of a conventional glass substrate.

In the following description, like parts are designated by like reference numbers throughout the several drawings.

### DETAILED DESCRIPTION OF THE PREFERRED EMBODIMENTS

### First Embodiment

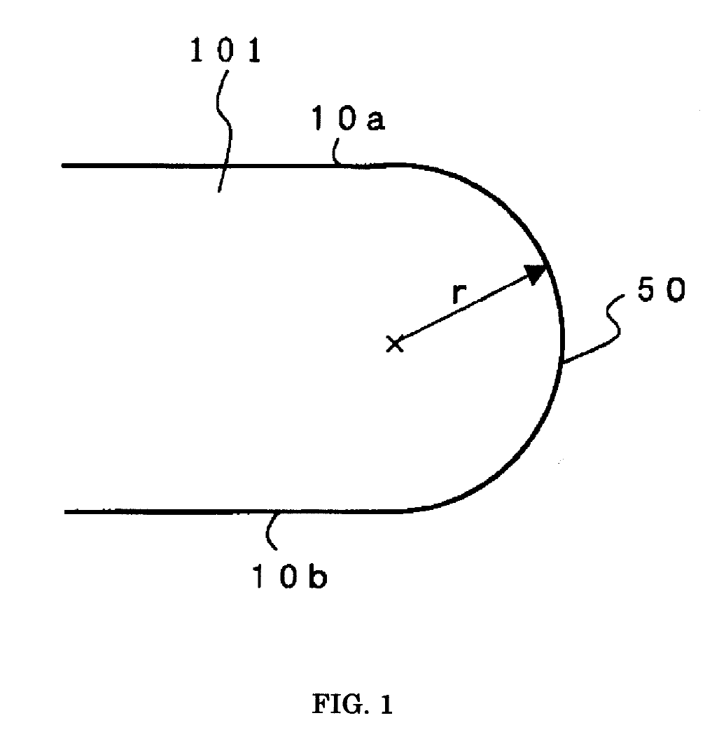

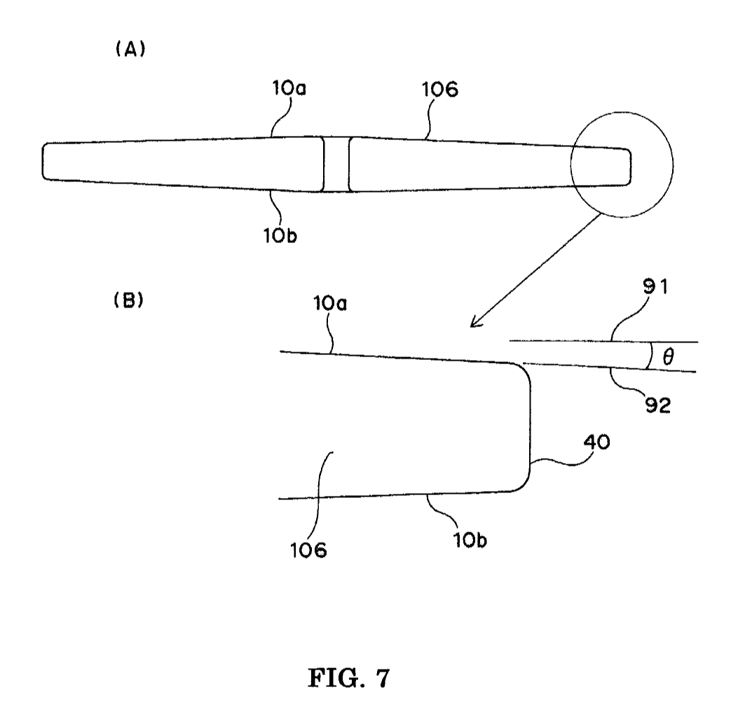

FIG. 1 is a sectional view of the end portion according to the first embodiment of the information recording medium glass substrate of the present invention. The entire structure of the glass substrate 101 is circular like in FIG. 7. An inside diameter portion is formed by boring a hole in the center. The front side main surface 10a and the rear side main surface 10b of the glass substrate 101 are smooth flat faces.

As shown in FIG. 1, the outside end portion of the glass substrate 101 is formed in the shape of sphere whose radius is half the thickness of a substrate in terms of sectional shape. Therefore, when the thickness of the substrate is assumed to be t (μm), a difference in height Δh1 (μm) between the main surface position and the convexly curved face outside end portion position (here, top of the sphere) is in the relation of Δh1≧t/150 regardless of the size of the substrate. For example, if the thickness of a 2.5 inch disk is 635 μl, the radius of the sphere is 317 μm and the difference in height Δh1 is 317 μm which is equal to the radius r of the sphere.

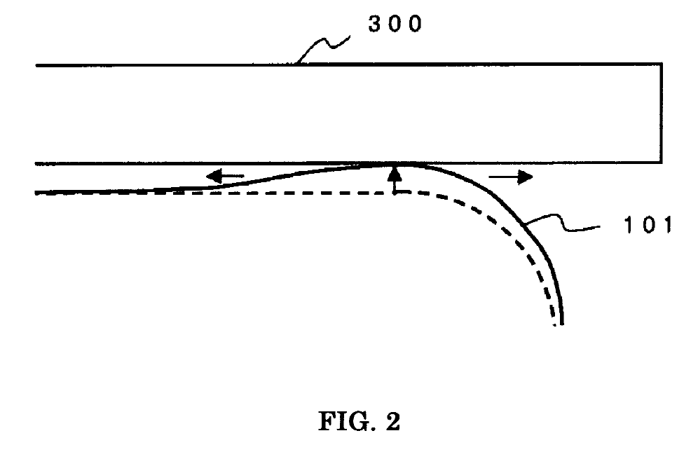

Due to such design of the shape of the outside end portion, even if when the information recording apparatus is dropped, its substrate is distorted so that the outside end portion makes contact with the ramp, the convexly curved face slides to contact the ramp 300 as shown schematically in FIG. 2, and it is estimated that it relaxes a shock due to the contact in terms of space and time. Therefore, no crack occurs due to concentration of stress to the vicinity of the boundary portion between the front side main surface 10a and the convexly curved face.

It can be considered that by providing a continuous convexly curved face which is large relative to the thickness of the substrate between the main surface and the side face, the shock at the time of collision with the ramp is relaxed and if the boundary portion between the main surface 10 and the convexly curved face is formed to be smooth to some extent (that is, a second convexly curved face is provided between the main surface and the convexly curved face), this is more effective for preventing generation of cracks. In this case, the second convexly curved face is required to have only a small curvature radius of 1/10− 1/10000 the curvature radius of the other convexly curved face. Of course, it is permissible that the main surface 10 is constructed to extend in tangent line to the sphere so that the main surface is connected smoothly to the sphere.

Because area between the rear side main surface 10b and the side face 50 is constructed in the same way as the front side, pulling stress at the time of collision with the ramp is dispersed to prevent cracks of the substrate more effectively.

### Second Embodiment

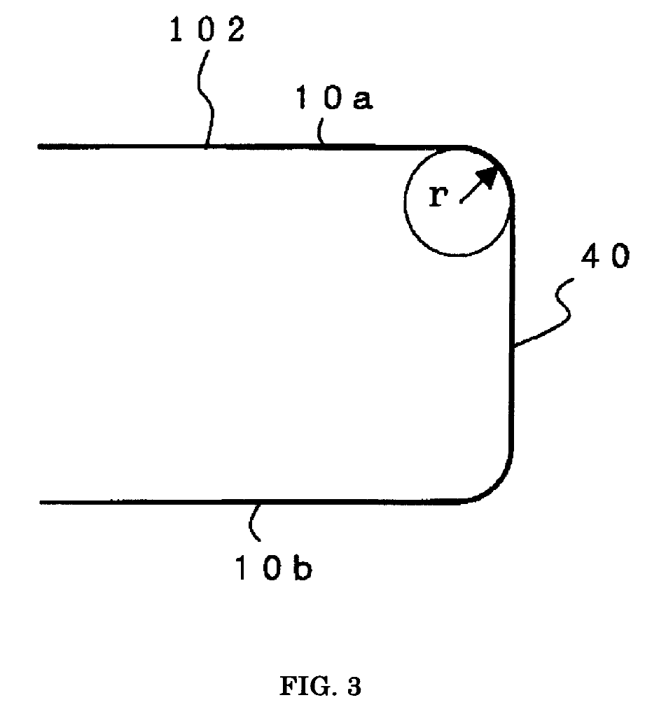

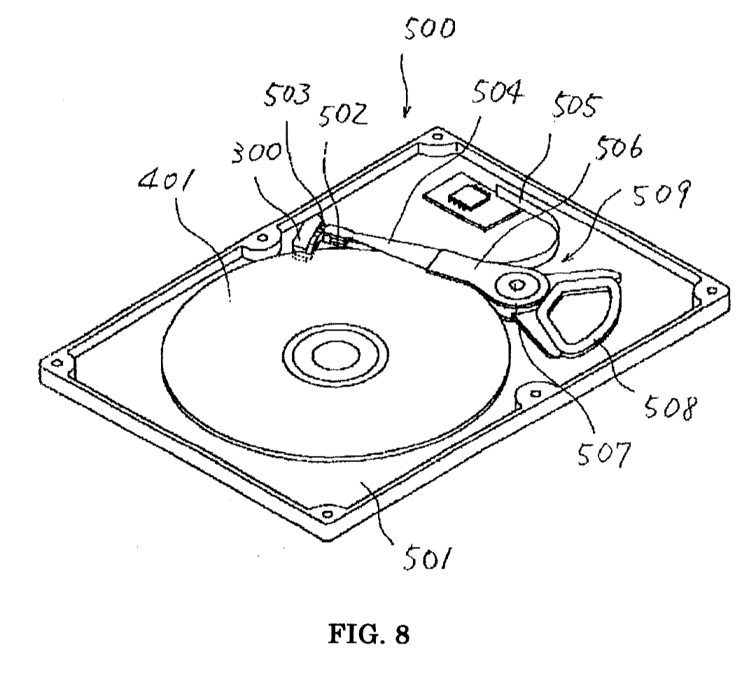

As shown in FIG. 3, the glass substrate 102 of this embodiment is formed so that a region corresponding to the chamfered portion 20 of the glass substrate of FIG. 8 is a sphere having a radius r. It can be said that a vertically flat side face is provided on the glass substrate in FIG. 1. The convexly curved face formed between the main surface 102 and the side face 40 can adopt various values if the difference in height Δh1 between the main surface position and the convexly curved face outside end portion position is in the relation of Δh1≧t/150 when it is assumed that thickness of the glass substrate is t (μm). More preferably, Δh1≧t/100 is adopted, and further preferably Δh1≧t/50 is adopted.

### Third Embodiment

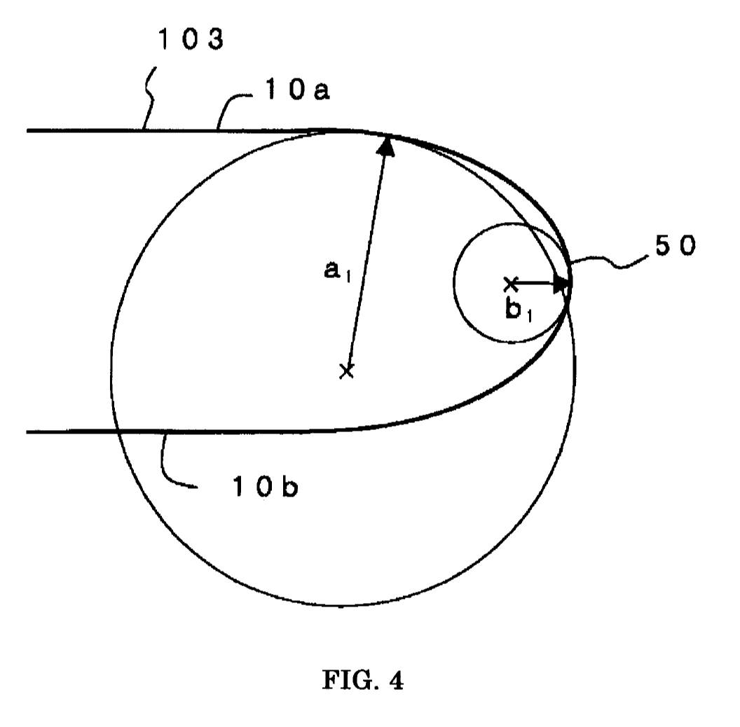

In the glass substrate 103 of this embodiment, as shown in FIG. 4, its side face portion is of laterally long elliptic shape in its vertically sectional shape. By forming the section of the convexly curved face into the laterally long elliptic shape, connection from the main surface to the curved face can be made smoother. If the main surface is connected more smoothly to the curved face, concentration of stress becomes unlikely to occur.

Although the difference in height Δh1 between the main surface position and the outside end portion position of the convexly curved face is set up as described previously, setting so that the curvature radius is reduced from the main surface side to the side face is preferable. In this case, it is permissible to construct a continuous convexly curved face whose curvature radius r (μm) is preferably set to t/100≧r≧1000t, and is more preferably set to t/20≧r≧100t.

### Fourth Embodiment

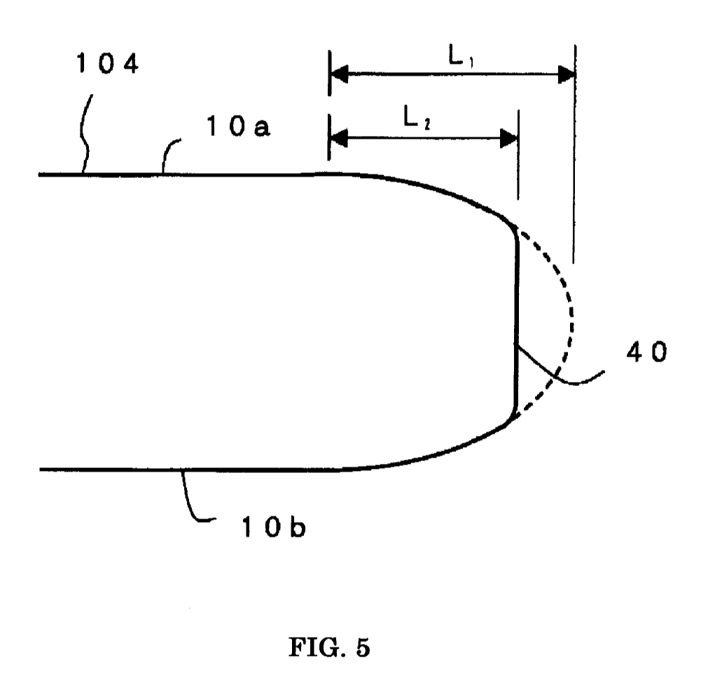

In the glass substrate 104 of this embodiment as shown in FIG. 5, its vertically sectional shape is in such a shape that the endmost portion of the second embodiment is cut out.

In addition to the effect of the third embodiment, because the curved portion length L₂ can be shortened, the size of the substrate can be reduced.

### Fifth Embodiment

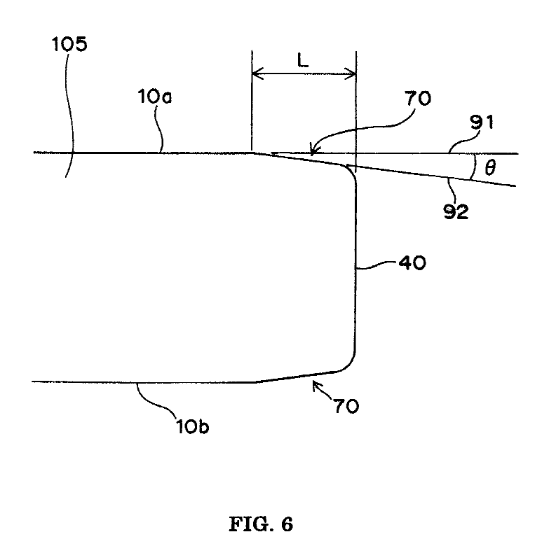

In the glass substrate 105 of this embodiment, as shown in FIG. 6, an inclined chamfered portion 70, which is inclined so that its vertically sectional shape narrows gradually toward the end, is disposed on the boundary between the main surface 10a and the outside face 40. By disposing the inclined chamfered portion 70 which narrows gradually toward its end, connection from the main surface 10a to the outside face 40 can be made smoother. By connecting from the main surface 10a smoothly, concentration of stress becomes unlikely to occur. It is preferable that the length L in the diameter direction of the inclined chamfered portion 70 is 5 mm or more and angle θ formed by a reference plane 91 and an inclined face 92 of the inclined chamfered portion is 5-20°. It is more preferable that the length L in the diameter direction of the inclined chamfered portion 70 is 10 mm or less.

### Sixth Embodiment

In the glass substrate 106 of this embodiment, as shown in FIG. 7, the main surface 10a is inclined slightly so that the thickness of the substrate 106 narrows entirely from the central portion (that is, the inside diameter portion) to the outside face 40. Because the main surface 10a is inclined entirely such that it narrows gradually from the central portion to the outside face 40, connection from the main surface 10a to the outside face 40 can be made smoother. By connecting from the main surface 10a smoothly, concentration of stress becomes unlikely to occur. An inclination angle θ formed by the reference plane 91 and the inclined face 92 of the main surface 10a is preferred to be 15° or less. Further, the inclination angle θ of the main surface 10a is preferred to be constant or increased continuously toward the outside face, that is, draw a smooth circle.

Although in any above embodiments, an influence of the concentration of stress on the boundary between the side face and the curved face at the time of collision with the ramp is not so large, preferably, the corner portion of the boundary is removed in order to prevent generation of particles due to rubbing with the accommodating container.

### (Manufacturing Method of Substrate)

A circular glass substrate is obtained by direct press after melting glass material or cutting out from a sheet glass formed by down draw method or the like by means of a grinding stone. That glass substrate is ground to a desired thickness using the diamond grinding stone or the like. Then, each face thereof is ground to a desired surface roughness using a grinding stone having a finer particle size than the aforementioned grinding stone. After that, the central portion is bored using a cylindrical grinding stone and the inside and outside peripheral faces are ground and chamfered. After that, end face grinding is carried out by brush grinding or mechanical grinding using grinding solution with the glass substrate rotating so that the surface roughness of the internal peripheral and external peripheral end faces of the glass substrate is within a predetermined range. After that, lapping is carried out by spraying grinding particles by means of a lapping unit so as to make the surface roughness small. Finally, polishing is carried out by means of a polisher (washing is carried out in each step as required). As a result, an information recording medium glass substrate is obtained. A glass substrate having the structure shown in the above respective embodiments is obtained by adjusting the condition of steps from the end face grinding to the polishing.

More specifically, each glass plate is finished in its end face shape using a drum-like grinding stone. After that, end face grinding is carried out with a rotating nylon brush roller kept in contact with the end face while supplying grinding solution. At this time, roundness is created at the top and bottom of a substrate by processing plural substrates with a spacer between adjacent ones at the same time thereby reducing processing time. After that, the main surface is ground. In the meantime, if chemical strengthening is intended, grinding condition is set up estimating deformation due to the chemical strengthening to gain the aforementioned shape after the chemical strengthening.

### (Material of Glass Substrate and the Like)

The material of the glass substrate is not restricted to any particular one but it is permissible to use various kinds of glasses or glass ceramics conventionally known. Glass ceramics such as alumino silicate glass, soda lime glass, soda alumino silicate glass, alumino borosilicate glass, borosilicate glass, quartz glass, chain silicate glass and crystallized glass can be mentioned. Glass undergoing such chemical strengthening process as dealkalization process or ion exchange may be used. Although the glass subjected to the chemical strengthening processing can improve its impact resistance and vibration resistance, the present invention is capable of preventing even a glass free from the chemical strengthening processing from being cracked by collision with the ramp.

As the alumino silicate glass, desired chemical strengthening glass contains SiO₂: 62-75 weight %, Al₂O₃: 5-15 weight %, Li₂O: 4-10 weight %, Na₂O: 4-12 weight %, ZrO₂: 5.5-15 weight % as its main component while the weight ratio of Na₂O/ZrO₂ is 0.5-2.0 and the weight ratio of AL₂O₃/ZrO₃ is 0.4-2.5.

Further, to eliminate any protrusion on the glass substrate surface generated for the reason of non-dissolved substance of ZrO₂, it is preferable to use a chemical strengthening glass containing SiO₂ 57-74%, ZnO₂ 0-2.8%, Al₂O₃ 3-15%, LiO₂ 7-16%, Na₂O 4-14% when expressed in mole %. In the alumino silicate glass and the like having such a composition, its bending resistance increases and its compression stress layer is deep and its surface hardness is excellent by undergoing chemical strengthening processing.

According to the present invention, the surface of the glass substrate can undergo chemical strengthening processing by low-temperature ion exchange method in order to improve the impact resistance and vibration resistance. Although the chemical strengthening method is not restricted to any particular one as long as it is a conventionally known chemical strengthening method, low-temperature chemical strengthening in which ion exchange is carried out within a region not exceeding a transition temperature from viewpoint of glass transition point is preferable, for example. As alkali fusion salt, potassium nitrate, sodium nitrate or nitrate which is mixture of those can be mentioned.

### (Size and Thickness of Substrate)

The substrate size is not limited to any particular one but it is permissible to use various kinds of sizes, 0.85 inch, 1 inch, 2.5 inch, 3 inch and 3.5 inch. The substrate thickness is not restricted to any particular one either but it is permissible to select one fitting to the substrate size appropriately.

### (Manufacturing Method of Magnetic Disk)

A magnetic disk which is an information recording medium is manufactured by forming foundation layer, magnetic layer, protective layer and lubrication layer successively on a glass substrate obtained in the above method.

Usually the magnetic recording medium has a predetermined flatness and surface roughness and is manufactured by stacking the foundation layer, magnetic layer, the protective layer and the lubrication layer successively on a magnetic disk glass substrate subjected to the chemical strengthening treatment as required.

The foundation layer is selected in accordance with the magnetic layer. For example, a foundation layer composed of at least one or more materials selected from non-magnetic metals such as Cr, Mo, Ta, Ti, W, V, B, Al and the like can be mentioned. In case of magnetic layer composed of mainly Co, Cr itself or Cr alloy is preferred from viewpoint of improvement in magnetic characteristic and the like. Further, the foundation layer is not always a single layer but may be of plural layer structure in which plural layers of the same kind or different kinds are stacked. For example, multi-layer foundation layer such as Cr/Cr, Cr/CrMo, Cr/CrV, CrV/CrV, Al/Cr/CrMo, Al/Cr/Cr, Al/Cr/CrV, Al/CrV/CrV and the like can be mentioned.

The material of the magnetic layer in the magnetic recording medium is not restricted to any particular one. As the magnetic layer, for example, magnetic thin films such as CoPt, CoCr, CoNi, CoNiCr, CoCrTa, CoPtCr, CoNiPt, CoNiCrPt, CoNiCrTa, CoCrTaPt, CoCrPtSiO and the like which contain Co as their main component can be mentioned. The magnetic layer may be of multi-layer structure (for example, CoPtCr/CrMo/CoPtCr, CoCrTaPt/CrMo/CoCrTaPt and the like) which intends to reduce noise by dividing the magnetic film with non-magnetic film (for example, Cr, CrMo, CrV and the like).

Magnetic layer corresponding to a magneto-resistive head (MR head) or a giant magneto-resistive head (GMR head) adopts Co base alloy containing Y, Si, rear earth elements, impurity selected from Hf, Ge, Sn, Zn or oxide of these impurities.

The magnetic layer is permitted to be of granular structure in which magnetic particles such as Fe, Co, FeCo, CoNiPt are dispersed in the non-magnetic film composed of Ferrite base, iron-rare earth base, SiO₂, BN as well as the above-mentioned substances. Further, the magnetic layer may be of any recording type, internal face type or vertical type.

The protective layer in the magnetic recording medium is not limited to any particular one. As the protective layer, for example, Cr film, Cr alloy film, carbon film, zirconia film, silica film and the like can be mentioned. These protective films can be formed continuously together with the foundation layer and magnetic layer by means of an in-line type spattering unit. The protective film may be of single layer or of multi-layer structure composed of the same kind or different kinds.

It is permissible to form other protective layer on the aforementioned protective layer, or instead of the aforementioned protective layer. For example, instead of the protective layer, it is permissible to form silicone oxide (SiO₂) film by dispersing colloidal silica particles in solution of tetraalkoxylane diluted with alcohol and coating on the Cr film and then baking.

The lubrication layer on the magnetic recording medium is not limited to any particular one. The lubrication layer is formed by diluting perfluoro polyether (PFPE) with freon base solvent or the like and coating on the surface of a medium according to dipping method, spin coating method and spray method and then executing heat treatment as required.

(Embodiment Other than the Glass Substrate for Hard Disk)

The glass substrate obtained according to the present invention can be used as a glass substrate for electro optic disk such as magneto optical disk or optical disk.

### (Structure of Information Recording Apparatus)

FIG. 8 is a perspective view showing a load/unloading type hard disk drive provided with the magnetic disk. This hard disk drive 500 comprises a magnetic disk 401, a record reproducing head 502, a suspension 504 for supporting the record reproducing head 502, and a head actuator 509 including an arm 506 for fixing the suspension 504.

The head actuator 509 is mounted on a case 501 such that an arm 506 is rotatable with respect to a pivot 507. The head actuator 509 is rotated by a voice coil motor 508 provided on an opposite side to the suspension 504 across the pivot 507. Supply of electric power to the head actuator 509 and exchange of signals with the record reproducing head 502 are carried out through a flexible print substrate 505 fixed on the arm 506.

In this hard disk drive 500, a lift tab 503 is provided at the front end of the suspension 504 and by guiding the lift tab 503 to a position restricting ramp 300 mounted on the case 501 such that it overlaps the end portion of a disk 401, unloading of retreating the record reproducing head 502 outside of the surface top of the magnetic disk 401 and loading of landing the head 502 from outside of the disk 401 to the surface top are carried out.

The lift tab 503 is a protrusion provided at the front end of the suspension 504 and located on the side of the front end relative to the head 502. The position restricting ramp 300 has a slope which the lift tab 503 makes contact with and when the lift tab 503 is kept in contact with the slope of the ramp 300, a gap between two suspensions 504 is restricted to prevent a contact between the heads 502 and a contact between the head 502 and the disk 401.

The head 502 floats from the surface of the disk 401 due to air flow generated by rotation of the disk 401 mounted on a rotation spindle. Thus, when loading the head 502 on the surface of the disk 401, the lift tab 503 is supported by the position restricting ramp 300 until the head 502 reaches the surface top of the disk 401. When unloading the head 502 out of the disk 401, the lift tab 503 is supported by the position restricting ramp 300 before the head 502 goes out of the disk 401.

### Example

A specified amount of raw material powder was put into platinum crucible after weighing and after mixing, was melted in an electric furnace at 1550° C. After the raw material was melted sufficiently, an agitation blade was inserted into melted glass solution and agitated for about an hour. After that, the agitation blade was brought out and the solution was left for 30 minutes and then, by pouring the melted solution into a jig, a glass block was obtained. After that, each glass block was reheated up to near glass transition point of each glass and cooled gradually to remove distortion. The obtained glass block was sliced into a disc of 2.5 inch about 1.5 mm thick and its inside and outside peripheries were cut out coaxially using a cutter. Then, both faces were roughly ground, ground and washed to produce a glass substrate. Glass substrates 1-11 having various kinds of shapes of outside end portions were obtained by changing the grinding condition.

More specifically, upon grinding of the end face, the glass substrate was ground while rotated using slurry by brush grinding or mechanical grinding so that the surface roughness of the inside and outside peripheral end faces was within a predetermined range. For samples 1-8, the shape of a drum-like grinding stone used in end face grinding was changed and by changing the rotation speed of the brush, grinding time, abrasive powder and the like, a condition for different radius was determined. For sample 8, a grinding condition for forming only a flat chamfered portion between the main surface and the side face was determined. For sample 9, a grinding condition for forming a curved face only between the main surface and the flat chamfered portion and between the flat chamfered portion and the side face in a glass substrate produced in the same manner as the sample 8 was determined. For sample 10, a grinding condition in which no chamfered portion or curved face was provided between the main surface and the side face was adopted. As for samples 21, 22, by inclining the grinding stone at a predetermined angle to the reference plane, the main surface was kept inclined partially or entirely.

As for glass composition, if expressed in mol %, SiO₂ was 66.8%, Al₂O₃ was 11.3%, B₂O₃ was 3.4%, Li₂O was 2.5%, Na₂O was 7.0%, K₂O was 2.5%, CaO was 3.0%, TiO₂ was 1.9%, ZrO₂ was 0.6%, La₂O₃ was 0.7% and Sb₂O₃ was 0.3%.

By forming magnetic layer on an obtained glass substrate, the information recording medium 1-11 and 21, 22 were obtained. After this information recording medium was set on a ramp load type hard disk drive, whether or not grounding occurred due to rubbing with a container was inspected. Further, fall test was carried out to investigate whether or not crack occurs in the glass substrate. Tables 1, 2 show the results.

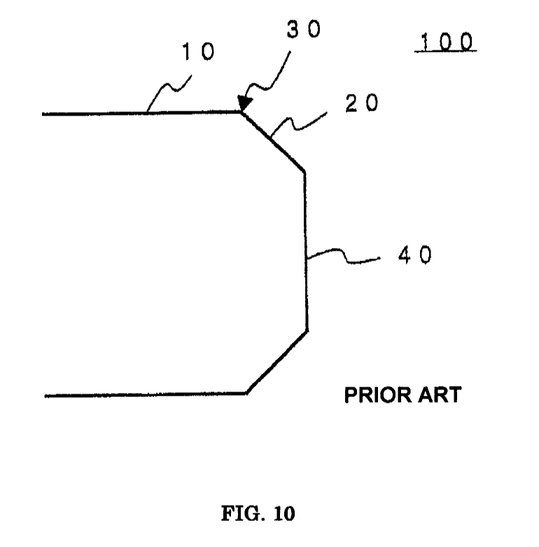

TABLE 1

| | Sectional | | | |
|---|---|---|---|---|
| | shape of | | | Container |
| | outside | | Damage | grounding |
| Sample | end | Radius of corner | test by | due to |
| No. | portion | portion R (μm) | fall | rubbing |
| 1 | FIG. 3 | 75 | No | No |
| | | | crack | grounding |
| 2 | FIG. 3 | 50 | No | No |
| | | | crack | grounding |
| 3 | FIG. 3 | 100 | No | No |
| | | | crack | grounding |
| 4 | FIG. 3 | 20 | No | No |
| | | | crack | grounding |
| 5 | FIG. 3 | 200 | No | No |
| | | | crack | grounding |
| 6 | FIG. 1 | 317 | No | No |
| | | | crack | grounding |
| 7 | FIG. 4 | Curvature radius a1 = | No | No |
| | | 980 | crack | grounding |
| | | Curvature radius b1 = | | |
| | | 170 | | |
| 8 | FIG. 5 | Curvature radius a1 = | No | No |
| | | 980 | crack | grounding |
| | | Curvature radius b1 = | | |
| | | 170 | | |
| 9 | FIG. 10 | No roundness on the | Crack | Grounding |
| | | corner portion | occurs | occurs |
| 10 | (FIG. 10) | Roundness is provided | Crack | No |
| | | only between main | occurs | grounding |
| | | surface and chamfered | | |
| | | portion and between | | |
| | | the chamfered portion | | |
| | | and side face. | | |
| 11 | (FIG. 3) | No roundness on the | No | Grounding |
| | | corner portion | crack | occurs |

TABLE 2

| | Sectional | | | |
|---|---|---|---|---|
| | shape of | Inclined portion | | Container |
| | outside | shape | Damage | grounding |
| Sample | end | angle (degree)/ | test by | due to |
| No. | portion | length (mm) | fall | rubbing |
| 21 | FIG. 6 | 75 | No | No |
| | | | crack | grounding |
| 22 | FIG. 7 | 50 | No | No |
| | | | crack | grounding |

As indicated in Tables 1, 2, it was verified that a glass substrate was not cracked and no grounding occurred due to rubbing with the container in the information recording medium of the present invention. That is, by inclining the position of the glass substrate opposing the ramp on the main surface with respect to the center axis of the glass substrate, cracks in the glass substrate could be prevented.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

1.-25. (canceled)

26. An information recording apparatus comprising:
an information recording medium in which a recording layer is provided on a main surface of a glass substrate;
a drive mechanism for rotating the information recording medium around a central axis perpendicular to the glass substrate;
a head for executing read/write of the information recording medium;
a ramp disposed such that its front end overlaps the end portion of the information recording medium; and
a head drive mechanism for loading the head retreated to the ramp on the information recording medium and unloading the head to the ramp,
wherein the main surface is inclined so that the thickness of the glass substrate narrows from the central axis to the flat side face of the glass substrate.

27. An information recording apparatus according to claim 26, wherein the glass substrate has an inside diameter portion, and the main surface is inclined so that the thickness narrows from the inside diameter portion to the flat side face.

28. An information recording apparatus comprising:
an information recording medium in which a recording layer is provided on a main surface of a glass substrate;
a drive mechanism for rotating the information recording medium around a central axis perpendicular to the glass substrate;
a head for executing read/write of the information recording medium;
a ramp disposed such that its front end overlaps the end portion of the information recording medium; and
a head drive mechanism for loading the head retreated to the ramp on the information recording medium and unloading the head to the ramp,
wherein the main surface has an inclined face so that the thickness of the glass substrate narrows from a central portion to an outer edge of the glass substrate.

29. An information recording apparatus comprising:
an information recording medium in which a recording layer is provided on a main surface of a glass substrate;
a drive mechanism for rotating the information recording medium around a central axis perpendicular to the glass substrate;
a head for executing read/write of the information recording medium;
a ramp disposed such that its front end overlaps the end portion of the information recording medium; and
a head drive mechanism for loading the head retreated to the ramp on the information recording medium and unloading the head to the ramp,
wherein the position of said main surface opposing said ramp is inclined with respect to said central axis, and
wherein the glass substrate includes a side face portion, said side face portion having a laterally long elliptical shape.

30. An information recording apparatus comprising:
an information recording medium in which a recording layer is provided on a main surface of a glass substrate;
a drive mechanism for rotating the information recording medium around a central axis perpendicular to the glass substrate;
a head for executing read/write of the information recording medium;
a ramp disposed such that its front end overlaps the end portion of the information recording medium; and
a head drive mechanism for loading the head retreated to the ramp on the information recording medium and unloading the head to the ramp,
wherein a continuous convexly curved face is formed at the position of said main surface opposing said ramp, and the following condition is fulfilled:
Δh1≧t/150
when
Δh1 (μm): a difference in height between the main surface position and an outside end portion position of the continuous convexly curved face,
t (μm): a thickness of the glass substrate, and
wherein the glass substrate includes a side face portion, said side face portion having a laterally long elliptical shape.
